(19) United States
(12) Patent Application Publication
(10) Pub. No.: US 2019/0352191 A1
(43) Pub. Date: Nov. 21, 2019

(54) WATER ACTIVATOR AND COOLING WATER CIRCULATION SYSTEM EQUIPPED WITH SAME

(71) Applicant: TOYOTA BOSHOKU KABUSHIKI KAISHA, Aichi (JP)

(72) Inventor: Masasuke NAGATA, Kariya-shi (JP)

(73) Assignee: TOYOTA BOSHOKU KABUSHIKI KAISHA, Aichi (JP)

(21) Appl. No.: 16/484,642

(22) PCT Filed: Apr. 26, 2018
(86) PCT No.: PCT/JP2018/017095

§ 371 Date: Aug. 8, 2019

(30) Foreign Application Priority Data
May 15, 2017 (JP) 2017-096789

(51) Int. Cl. C02F 1/00; C02F 1/68

(52) U.S. Cl. CPC C02F 1/001; C02F 2001/007; C02F 1/68

(57) ABSTRACT

A water activator of the present application includes a cylindrical tank, a double cylindrical container concentrically arranged within the tank, and a plurality of granular water activating materials (ceramic balls) filled in the container. The container includes a bottom plate, an inner cylinder, an outer cylinder, and a lid plate. Among the bottom plate, the inner cylinder, the outer cylinder and the lid plate, a cylindrical filling space in which the plurality of granular water activating materials are filled over the axial direction is formed, and each of the inner cylinder and the outer cylinder is formed to regulate the passage of the granular water activating materials and allow the passage of water. Furthermore, an inlet is provided to allow water to flow tangentially into the tank, and an outlet is provided to allow the water inside the inner cylinder of the container to flow out of the tank.

### TECHNICAL FIELD

The present invention relates to a water activator and a cooling water circulation system including the same, and more particularly, to a water activator for activating water using a large number of granular water activating materials and a cooling water circulation system including the same.

### BACKGROUND ART

As conventional water activators, one which activates water using a large number of granular water activating materials is generally known (see, for example, Patent Literatures 1 and 2). Patent Literature 1 describes a water activator that allows water to flow upward while swirling water from the lower side of a container in which a plurality of ceramic balls (granular water activating materials) are placed at the center. Further, Patent Literature 2 describes a water activation structure in which a plurality of ceramic balls arranged in a thin layer form are held from the side by a frame to flow water.

### CITATIONS LIST

### Patent Literature

Patent Literature 1: JP 1405-15872 A

Patent Literature 2: JP 2014-8488 A

### SUMMARY OF INVENTION

### Technical Problems

However, in the case of the water activator described in Patent Literature 1 presented above, since the ceramic balls are contained in a space about half the volume of the container, the ceramic balls are stirred by the force of water flowing into the container and easily worn (including fracture and breakage). As a result, the replacement cycle for ceramic balls is shortened. On the other hand, if the ceramic balls are filled in the container in a full state so as not to be worn, the pressure loss of water increases, making it difficult for water to flow, resulting in an insufficient flow rate. Furthermore, in the water activation structure described in Patent Literature 2 presented above, since the ceramic balls are held in a thin layer form in the frame, the size increases in the case of activation of a large quantity of water.

Here, the above problems occur even in the case of activation of water in the water supply system (i.e., drinking water or the like), but particularly occur in the case of activation of cooling water circulated in a circulation route in factory facilities or the like. This is because impurities such as sludge are easily mixed in the cooling water and the cooling water is circulated in a large quantity and at high water pressure. Furthermore, the above problems similarly occur even with granular water activating materials other than ceramic halls, such as tourmaline granules and activated carbon granules.

In addition, in the cooling tower circulation and chiller circulation used in factory facilities or the like, the scale adhesion and deposit, flow path obstruction/corrosion, rust, water leakage/generation of slime and algae in the mold cooling holes, the cooling pipes, the heat exchanger, etc. occur due to the deterioration in water quality of the cooling water. As a result, there occur various problems such as: the destabilization of the quality of the molded article (the mold cannot be maintained at a constant temperature, silver defects due to insufficient cooling are likely to occur), waste of power and energy (increase in power consumption due to reduction in heat exchange rate of the heat exchanger, increase in CO2 emissions, and increase in high pressure abnormal troubles in the heat exchanger), and increase in facility management cost (increase in electricity charges for facilities, increase in chemical cleaning cost, and increase in cleaning maintenance cost). Therefore, the appearance of a cooling water circulation system capable of circulating cooling water with improved water quality is desired.

The present invention has been made in view of the above-described actual situation, and an object thereof is to provide a water activator capable of effectively activating water while suppressing the pressure loss and also capable of prolonging the replacement cycle for granular water activating materials or eliminating the replacement thereof, and a cooling water circulation system including the same.

### Solutions To Problems

In order to solve the above problem, the invention as defined in claim I relates to a water activator for activating water, comprising: a cylindrical tank provided with a water inlet on one axial end side and a water outlet on another axial end side; a double cylindrical container concentrically arranged within the tank; and a plurality of granular water activating materials filled in the container, wherein the container includes a bottom plate, an inner cylinder whose one axial end side is joined onto the bottom plate, an outer cylinder whose one axial end side is joined onto the bottom plate and which is arranged outside the inner cylinder, and a lid plate covered on the other axial end sides of the inner cylinder and the outer cylinder, wherein a cylindrical filling space in which the plurality of granular water activating materials are filled over an axial direction is formed among the bottom plate, the inner cylinder, the outer cylinder, and the lid plate, wherein each of the inner cylinder and the outer cylinder is formed to regulate passage of the granular water activating materials and to allow passage of water, wherein the inlet is provided to allow water to flow tangentially into the tank, and wherein the outlet is provided to allow the water inside the inner cylinder of the container to flow out of the tank.

The invention as defined in claim 2 relates to the water activator according to claim 1, wherein the tank is installed so that one axial end side forms a bottom part and that another axial end side forms a top part.

The invention as defined in claim 3 relates to the water activator according to claim 2, wherein a partition plate which partitions an inside of the tank vertically into a container-side space and an impurity recovery space is provided in the bottom part of the tank, and wherein the partition plate is provided with a communication part for communicating a space outside the outer cylinder in the container-side space with the impurity recovery space.

The invention as defined in claim 4 relates to the water activator according to any one of claims 1 to 3, wherein at least the inner cylinder of the inner cylinder and the outer cylinder is formed of woven wire mesh.

The invention as defined in claim 5 relates to the water activator according to any one of claims 1 to 4, wherein the tank includes a bottomed cylindrical main body opened on one axial end side, and a lid member detachably attached to an axial end side of the main body so as to close the opening of the main body, and wherein the lid member is provided with a see-through part through which an inside of the main body can be seen.

The invention as defined in claim 6 relates to the water activator according to any one of claims 1 to 5, wherein the inlet includes an inflow nozzle connected to an outer peripheral surface of the tank, and wherein the inflow nozzle is arranged so that its axial center is parallel to a reference line orthogonal to an axial center of the tank as viewed from an axial direction of the tank.

The invention as defined in claim 7 relates to the water activator according to any one of claims 1 to 6, wherein the container is provided in the tank so that the lid plate partitions the inside of the tank axially into the container-side space and an axial end-side space, wherein the lid plate is provided with a communication part for communicating a space inside the inner cylinder in the container-side space with the axial end-side space, and wherein the outlet is provided in a portion forming the axial end-side space of the tank.

The invention as defined in claim 8 relates to the water activator according to any one of claims 1 to 7, wherein the granular water activating materials are ceramic balls.

The invention as defined in claim 9 relates to the water activator according to any one of claims 1 to 8, wherein the water is cooling water circulated in a circulation route.

In order to solve the above problem, the invention as defined in claim 10 relates to a cooling water circulation system for circulating cooling water in a circulation route, wherein the water activator according to any one of claims 1 to 9 is provided in the circulation route.

### Advantageous Effects of Invention

The water activator of the present invention includes a cylindrical tank provided with a water inlet on one axial end side and a water outlet on another axial end side, a double cylindrical container concentrically arranged within the tank, and a plurality of granular water activating materials filled in the container. The container includes a bottom plate, an inner cylinder whose one axial end side is joined onto the bottom plate, an outer cylinder whose one axial end side is joined onto the bottom plate and which is arranged outside the inner cylinder, and a lid plate covered on the other axial end sides of the inner cylinder and the outer cylinder. Further, a cylindrical filling space in which the plurality of granular water activating materials are filled in an axial direction is formed among the bottom plate, the inner cylinder, the outer cylinder, and the lid plate. Each of the inner cylinder and the outer cylinder is formed to regulate passage of the granular water activating materials and to allow passage of water. Furthermore, the inlet is provided to allow water to flow tangentially into the tank, and the outlet is provided to allow the water inside the inner cylinder of the container to flow out of the tank.

Thus, the water which flows from the inlet tangentially into the tank becomes a rotational flow around the axial center in the tank and flows spirally from one axial end side of the tank toward the other axial end side. Then, the water flows vigorously throughout the entire filling space of the container, passes between the respective granular water activating materials, and flows out of the tank from the inside of the inner cylinder of the container through the outlet. In this manner, the water flowing vigorously throughout the entire cylindrical filling space, when coming in contact with the granular water activating materials, is effectively activated while suppressing the pressure loss. In addition, since the plurality of granular water activating materials are filled in the cylindrical filling space in a full state, the granular water activating materials are hard to be stirred by the force of water and worn, thereby making it possible to prolong the replacement cycle for granular water activating materials or to eliminate the replacement thereof. Furthermore, as compared with conventional ones in which ceramic balls are held in a thin layer form in a frame, the water activator can be downsized as a whole.

In addition, when the tank is installed so that one axial end side forms a bottom part and that another axial end side forms a top part, water flows spirally from the bottom part of the tank toward the top part, whereby the impurities to be contained in the water are collected by the centrifugal force on the outside of the outer cylinder and dropped. Therefore, the impurities can be easily recovered at the bottom part of the tank.

Further, when a partition plate which partitions the inside of the tank vertically into a container-side space and an impurity recovery space is provided in the bottom part of the tank, and the partition plate is provided with a communication part for communicating a space outside the outer cylinder in the container-side space with the impurity recovery space, the impurities collected by the centrifugal force on the outside of the outer cylinder and dropped are recovered in the impurity recovery space through the communication part of the partition plate.

In addition, when at least the inner cylinder of the inner cylinder and the outer cylinder is formed of woven wire mesh, the wear of the granular water activating materials due to the contact with the inner cylinder is suppressed.

Further, when the tank includes a main body and a lid member, and the lid member is provided with a see-through part through which the inside of the main body can be seen, the state of the activated water can be confirmed by the see-through part.

In addition, when the inlet is provided with an inflow nozzle, and the inflow nozzle is arranged so that its axial center is parallel to a reference line orthogonal to the axial center of the tank as viewed from the axial direction of the tank, water flows tangentially into the tank by the inflow nozzle, so that a rotational flow of water around the axial center is effectively generated in the tank.

Further, when the container is provided in the tank so that the lid plate partitions an inside of the tank axially into the container-side space and an axial end-side space, the lid plate is provided with a communication part for communicating a space inside the inner cylinder in the container-side space with the axial end-side space, and the outlet is provided in a portion forming the axial end-side space of the tank, the water that has passed between the respective granular water activating materials reaches the axial end-side space from the inside of the inner cylinder through the communication part, and flows out of the tank through the outlet.

Further, when the granular water activating materials are ceramic balls, water is more effectively activated, for example, by the radiation effect of far infrared rays of the ceramic balls.

Furthermore, when the water is cooling water circulated in a circulation route, it is possible to effectively activate the cooling water circulated in a large quantity and at high water pressure.

According to the cooling water circulation system of the present invention, the above-described water activator is provided in the circulation route. As a result, it is possible to effectively activate the cooling water circulated in a large quantity and at high water pressure. By circulating the cooling water with improved water quality in the circulation route, it is possible to prevent the contamination and clogging of the circulation route, and to maintain the water quality of the cooling water.

### BRIEF DESCRIPTION OF DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a longitudinal cross-sectional view of a water activator according to an Example.

FIG. 2 is a longitudinal cross-sectional view showing the disassembled state of the water activator.

FIG. 3 is an enlarged cross-sectional view taken along line III-III of FIG. 1.

FIG. 4 is an enlarged cross-sectional view taken along line IV-IV of FIG. 2.

FIG. 5 is a longitudinal cross-sectional view of a container according to the Example.

FIG. 6 is an enlarged view of the essential part of an inner cylinder (outer cylinder) of the container.

FIG. 7 is an overall schematic view of a cooling water circulation system according to the Example.

FIG. 8 is an explanatory view for explaining a water activator of another form.

FIG. 9 is an explanatory view for explaining a water activator of still another form.

### DESCRIPTION OF EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### <Water Activator>

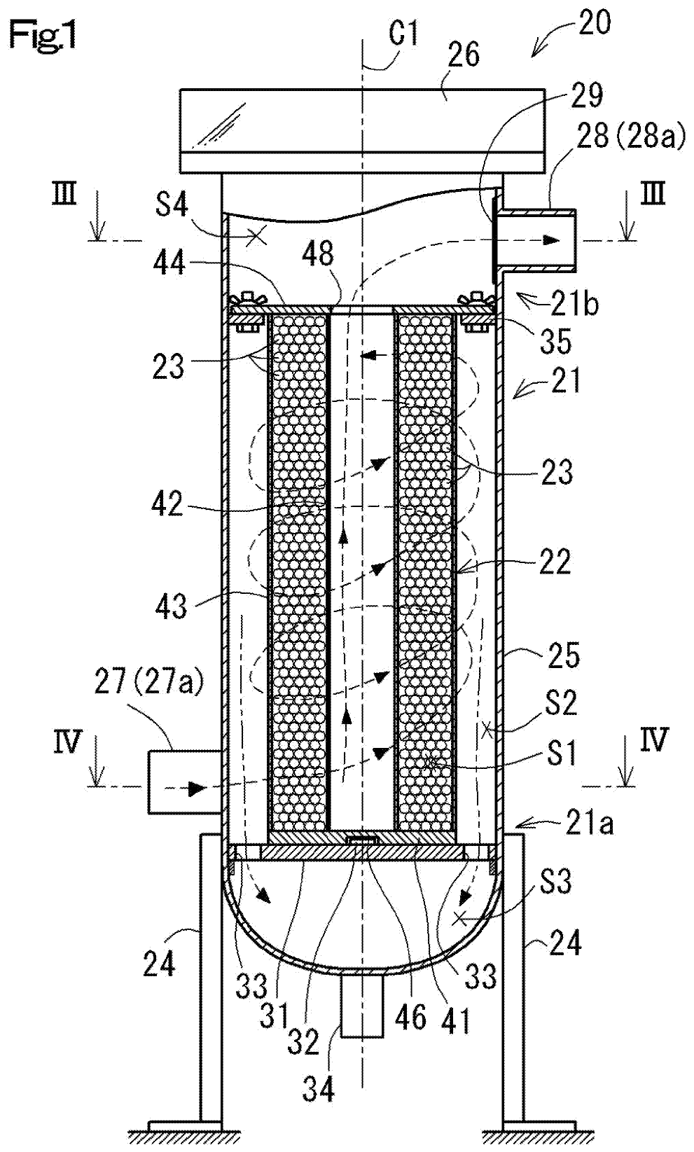

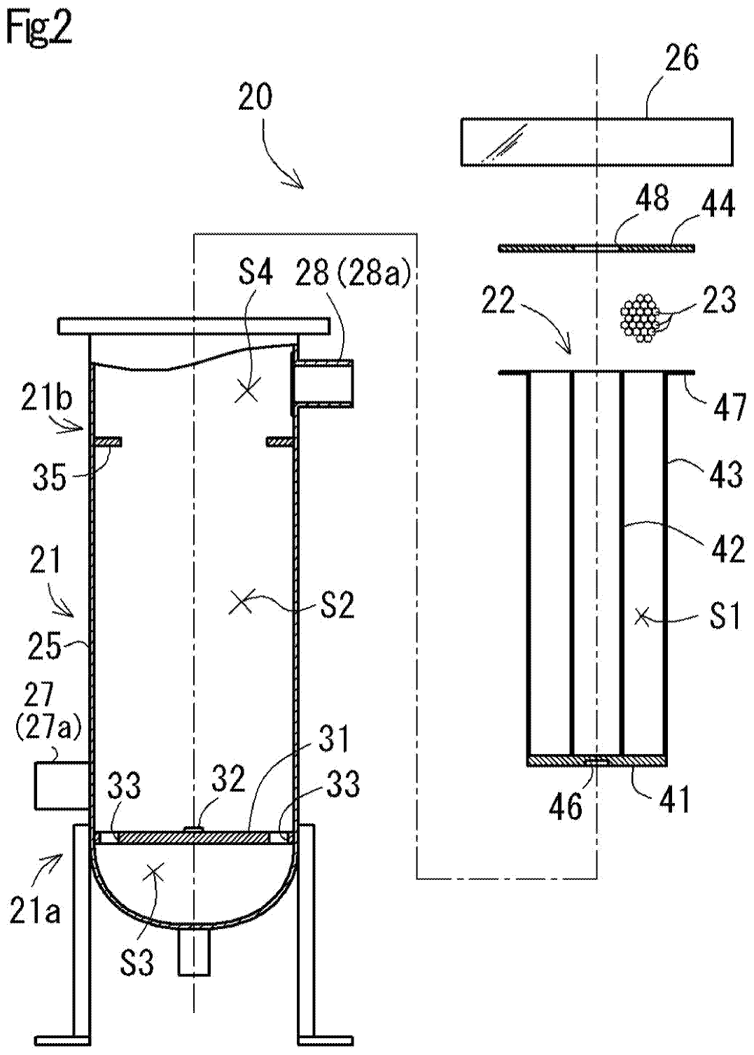

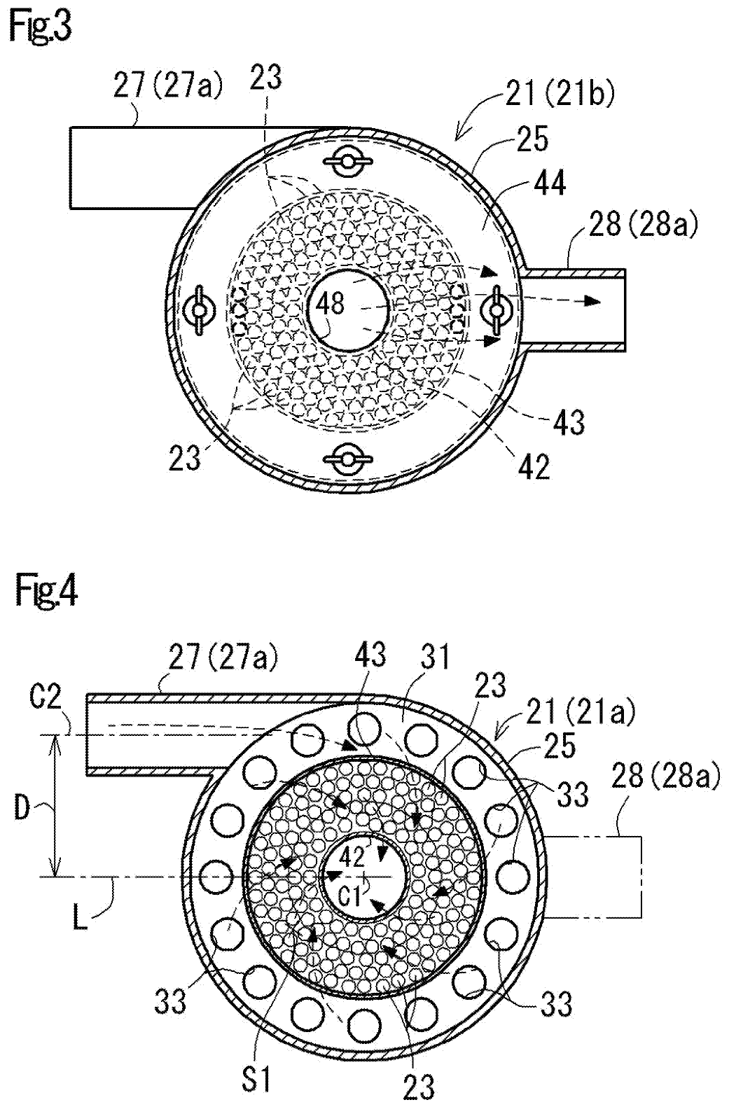

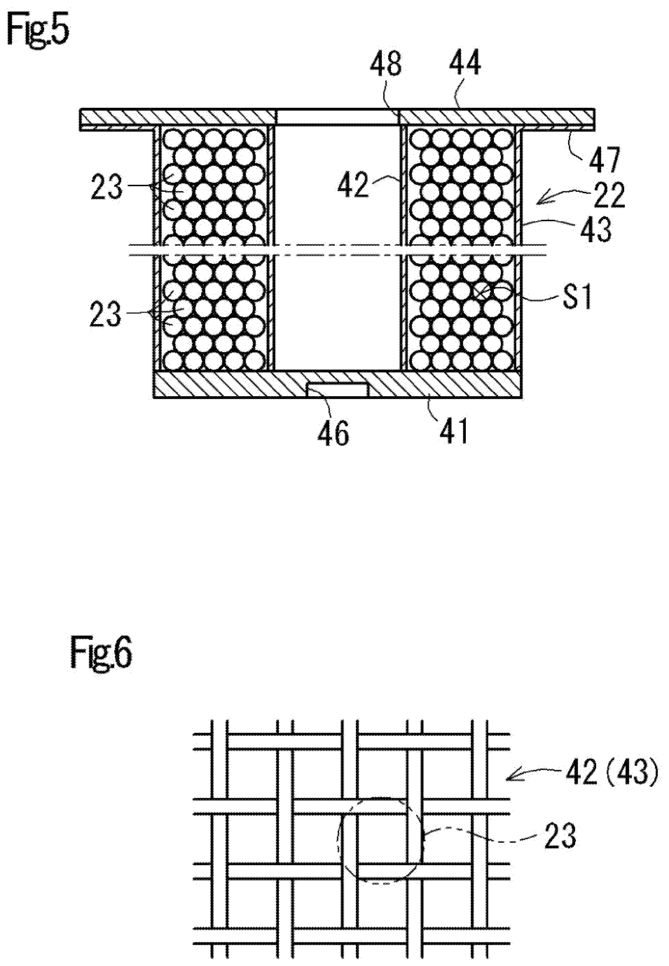

A water activator according to the present embodiment is a water activator (20) for activating water, including a cylindrical tank (21) in which a water inlet (27) is provided on one axial end side and a water outlet (28) is provided on the other axial end side, a double cylindrical container (22) arranged concentrically in the tank, and a plurality of granular water activating materials (23) filled in the container (see, for example, FIGS. 1 and 2). The container (22) includes a bottom plate (41), an inner cylinder (42) whose one axial end side is joined onto the bottom plate, an outer cylinder (43) whose one axial end side is joined onto the bottom plate and which is arranged outside the inner cylinder, and a lid plate (44) covered on the axial end sides of the inner cylinder and the outer cylinder. In addition, among the bottom plate (41), the inner cylinder (42), the outer cylinder (43) and the lid plate (44), a cylindrical filling space (S1) in which the plurality of granular water activating materials (23) are filled over the axial direction is formed, and each of the inner cylinder (42) and the outer cylinder (43) is formed to regulate the passage of the granular water activating materials and allow the passage of water (see, for example, FIGS. 5 and 6). Furthermore, the inlet (27) is provided to allow water to flow tangentially into the tank (21), and the outlet (28) is provided to allow the water inside the inner cylinder (42) of the container (22) to flow out of the tank (21) (see, for example, FIGS. 3 and 4).

In addition, the “activating water” as described above is intended to involve treating a cluster which is an aggregate of water molecules bonded by hydrogen bonds by a physical/chemical method to improve the water quality. Examples of the water quality improvement effect include improvement in permeability and cleaning function and alkalinity weakening. Further, the kind, flow rate, water pressure, etc. of the water are not particularly limited. Examples of this water include industrial water such as cooling water, tap water, underground water and rainwater. Further, the “tangentially” as described above is intended to mean the tangential direction of a circle centered on the axial center of the tank, and includes also a direction inclined at a crossing angle of ±5 degrees with respect to the tangential direction of the circle. This circle can have a diameter of, for example, more than 50% and less than 100% (in particular, more than 70% and less than 90%) of the inner diameter of the tank.

The kind, number, size and the like of the granular water activating materials are not particularly limited. Examples of the granular water activating materials include ceramic balls, tourmaline granules, activated carbon granules and zeolite balls. The ceramic balls can contain, for example, one or two or more of tourmaline, manganese and the like. The tourmaline supplies current to the contacting water by the piezoelectric effect to improve the water quality. Further, the diameter (maximum grain size) of the granular water activating materials is, for example, 1 to 20 mm (particularly, 3 to 10 mm).

As the water activator according to the present embodiment, for example, there is indicated a form in which the tank (21) is installed so that one axial end side forms a bottom part (21a) and the other axial end-side serves as top part (21b) (for example, see FIG. 1). In this form, the axial center of the tank may be along the perpendicular direction or may be inclined with respect to the perpendicular direction.

In the case of the above-described form, for example, the bottom part (21a) of the tank can be provided with a partition plate (31) which partitions the inside of the tank vertically into a container-side space (S2) and an impurity recovery space (S3), and the partition plate can be provided with a communication part (33) for communicating a space outside the outer cylinder (43) in the container-side space with the impurity recovery space (S3) (see, for example, FIG. 1). In this case, for example, the bottom plate (41) of the container (22) can be placed on the partition plate (31). Thus, the detachability of the container to the tank is enhanced.

As the water activator according to the present embodiment, for example, there is indicated a form in which at least the inner cylinder of the inner cylinder (42) and the outer cylinder (43) is formed of woven wire mesh (see, for example, FIG. 6). Examples of the woven wire mesh include plain woven wire mesh, twill woven wire mesh, plain dutch woven wire mesh, and twill dutch woven wire mesh.

As the water activator according to the present embodiment, for example, the tank (21) can include a bottomed cylindrical main body (25) opened on one axial end side, and a lid member (26) detachably attached to the axial end side of the main body so as to close the opening of the main body, and the lid member can be provided with a see-through part through which the inside of the main body can be seen (see, for example, FIG. 2).

As the water activator according to the present embodiment, for example, there is indicated a form in which the inlet (27) includes an inflow nozzle (27a) connected to the outer peripheral surface of the tank (21), and the inflow nozzle is arranged so that its axial center (C2) is parallel to a reference line (L) orthogonal to the axial center (C1) of the tank as viewed from the axial direction of the tank (see, for example, FIG. 4). The “parallel” as described above includes, in addition to the state in which the axial center (C2) of the inflow nozzle and the reference line (L) are completely parallel, a state in which they cross at an angle range of about ±5 degrees. Furthermore, a parallel distance (D) between the axial center (C2) of the inflow nozzle and the reference line (L) can be set, for example, to a value of more than 50% and less than 100% (especially, more than 70% and less than 90%) of the radius of the inner wall of the tank.

As the water activator according to the present embodiment, for example, the container (22) can be provided in the tank so that the lid plate (44) partitions the inside of the tank (21) axially into the container-side space (S2) and an axial end-side space (S4), the lid plate (44) can be provided with a communication part (48) for communicating a space inside the inner cylinder (42) in the container-side space (S2) with the axial end-side space (S4), and the outlet (28) can be provided in a portion forming the axial end-side space (S4) of the tank (21) (for example, see FIGS. 1 and 3).

### <Cooling Water Circulation System>

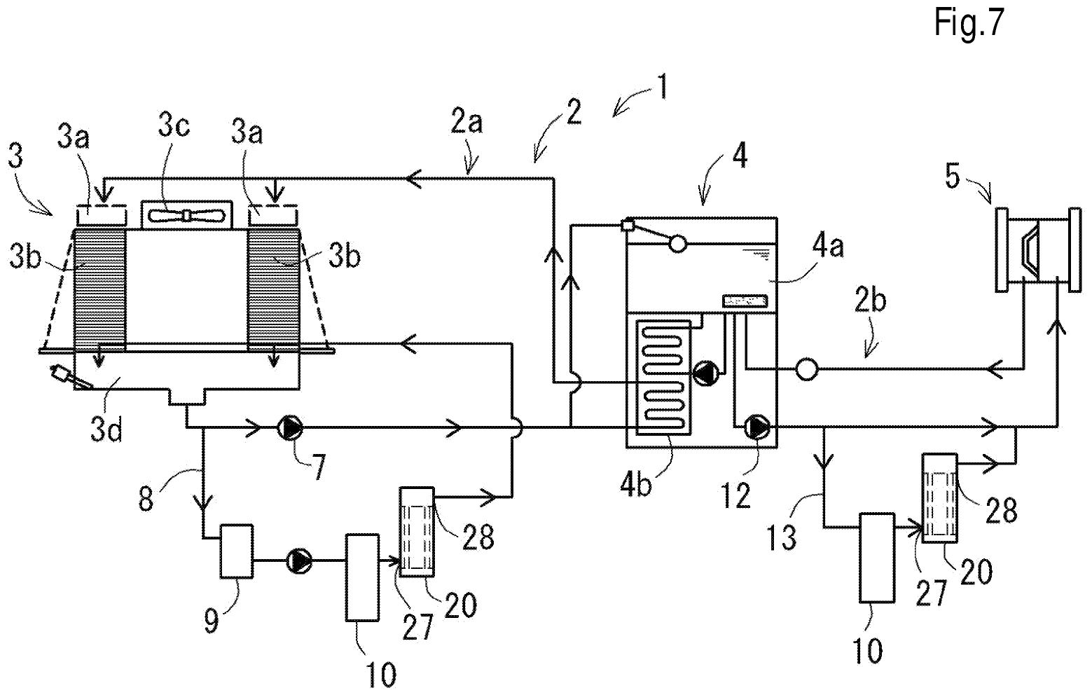

The cooling water circulation system according to the present embodiment is a cooling water circulation system (1) for circulating cooling water in a circulation route (2), wherein the water activator (20) according to the above embodiment is provided in the circulation route (see, for example, FIG. 7).

The circulation route (2) can include, for example, at least one circulation route of a cooling tower-side circulation route (2a) for circulating cooling water between a cooling tower (3) and a chiller (4) and a chiller-side circulation route (2b) for circulating cooling water between the chiller (4) and a part (7) to be cooled.

Note that reference signs in parentheses attached to the respective components described in the above embodiment indicate correspondence relationships with specific components referred to in the Examples that will be described later.

### EXAMPLES

Hereinafter, the present invention will be described in detail by way of Examples with reference to the accompanying drawings. In addition, in the present Example, a water activator that activates the cooling water circulated within the circulation route will be illustrated as the “water activator” of the present invention.

### (1) Configuration of Cooling Water Circulation System

A cooling water circulation system 1 according to the present Example is intended for circulating cooling water in a circulation route 2, as shown in FIG. 7. The circulation route 2 includes a cooling tower-side circulation route 2a for circulating cooling water between a cooling tower 3 and a chiller 4, and a chiller-side circulation route 2b for circulating the cooling water between the chiller 4 and a part 5 to be cooled (for example, an injection molding apparatus, a pressing apparatus, a welding apparatus, a heating device, or a trimming device). A water activator 20 which will be described later is provided in each of the circulation routes 2a and 2b.

The cooling tower 3 includes a water sprinkling tank 3a for storing and sprinkling the temperature-increased cooling water sent from the chiller 4, a filler 3b for cooling the cooling water sprinkled from the water sprinkling tank 3a, a blower 3c for taking in the outside air from an intake port and allowing the air to pass through the inside of the filler 3b, and a water tank 3d for storing the cooling water that has been cooled by the filler 3b and dropped. The chiller 4 is provided with a tank 4a for storing the temperature-increased cooling water sent from the part 5 to be cooled, and a heat exchanger 4b for cooling the cooling water within the tank 4a.

The feeding route of the cooling tower-side circulation route 2a is provided with a pressure pump 7 for pumping the cooling water within the water tank 3d of the cooling tower 3 toward the heat exchanger 4b of the chiller 4. Further, the other end side of a branch route 8 whose one end side is connected to the water tank 3d is connected to the upstream side of the pressure pump 7 in the feeding route. The branch route 8 includes a basket filter 9 containing a water treatment agent made of an inorganic substance or the like, an underwater impurity separator 10 for removing impurities (for example, impurities of 7 or more) contained in the cooling water, and a water activator 20 which will be described later, in this order.

The feeding route of the chiller-side circulation route 2b is provided with a pressure pump 12 for pumping the cooling water within the tank 4a of the chiller 4 toward the part 5 to be cooled. Further, a bypass route 13 is provided on the downstream side of the pressure pump 12 in the feeding route, The bypass route 13 includes an underwater impurity separator 10 for removing impurities (for example, an impurity of 7 μm or more) contained in the cooling water, and a water activator 20 described later, in this order.

### (2) Configuration of Water Activator

As shown in FIGS. 1 and 2, the water activator 20 according to the present Example includes a cylindrical tank 21, a double cylindrical container 22 concentrically arranged within the tank 21, and a plurality of ceramic balls (exemplified as “granular water activating materials” according to the present invention) 23 filled in a full state within the container 22.

The tank 21 includes a bottomed cylindrical main body 25 whose top part is opened, and a lid member 26 detachably attached to the top part of the main body 25 so as to close the opening of the main body 25. The main body 25 is made of a metal such as stainless steel. Further, leg parts 24 extending downward are provided in the lower part of the main body 25. By the leg parts 24, the tank 21 is installed so that one axial end side forms a bottom part 21a and the other axial end side forms a top part 21b. Specifically, the tank 21 is installed so that its axial direction is along the perpendicular direction. The lid member 26 is made of a transparent or translucent synthetic resin such as an acrylic resin. Therefore, the whole lid member 26 serves as a see-through part through which the inside of the main body 25 can be seen.

An inlet 27 is provided in the bottom part 21a of the tank 21 so as to allow the cooling water to flow tangentially into the tank 21. The inlet 27 is provided with an inflow nozzle 27a connected to the outer peripheral surface of the tank 21 (see FIG. 4). The inflow nozzle 27a is arranged so that its axial center C2 is parallel to a reference line L orthogonal to the axial center C1 of the tank 21 as viewed in the axial direction of the tank 21. A parallel distance D between the axial center C2 of the inflow nozzle and the reference line L is set to a value of about 80% of the radius of the inner wall of the tank 21. Further, in the top part 21b of the tank 21, an outlet 28 is provided so as to allow the cooling water inside the inner cylinder 42 of the container 22 to flow out of the tank 21, as will be described later. The outlet 28 is provided with an outflow nozzle 28a connected to the outer peripheral surface of the tank 21 and extending in a direction orthogonal to the axial center of the tank 21 (see FIG. 3). Furthermore, a filter 29 is provided in the top part of the tank 21 so as to cover the outlet 28. The filter 29 is formed of a perforated plate such as a punching metal. In addition, pipes which constitute the branch route 8 and the bypass route 13 are connected to the inflow nozzle 27a and the outflow nozzle 28a (see FIG. 7).

The bottom part 21a of the tank 21 is provided with a disk-shaped partition plate 31 which partitions the inside of the tank 21 vertically into a container-side space S2 (that is, a space S2 on the side where the container 22 is arranged) and an impurity recovery space S3. The partition plate 31 is made of a metal such as stainless steel. Further, a bottom plate 41 of the container 22 which will be described later is placed on the partition plate 31. Specifically, a concave portion 46 provided in the bottom plate 41 of the container 22 enters a convex portion 32 provided on the partition plate 31, so that the container 22 is placed in a state of being positioned on the partition plate 31. Further, the partition plate 31 is provided with a communication part 33 for communicating a space outside the outer cylinder 43 in the container-side space S2 with the impurity recovery space S3. The communication part 33 is constituted by a through hole formed in the partition plate 31, and a plurality (16 in FIG. 4) thereof are provided along the circumferential direction centered on the axial center of the partition plate 31 (see FIG. 4). Further, on the bottom surface side of the tank 21, a drain nozzle 34 for discharging the impurities recovered in the impurity recovery space 53 is provided. Further, a fixing flange 35 for fixing a lid plate 44 of the container 22 which will be described later is provided in the top part 21b of the tank 21. The fixing flange 35 is made of a metal such as stainless steel.

As shown in FIG. 5, the container 22 includes a disk-like bottom plate 41, a cylindrical inner cylinder 42 whose one axial end side is joined by welding, fitting, bolting or the like onto the bottom plate 41, a cylindrical outer cylinder 43 whose one axial end side is joined by welding, fitting, bolting or the like onto the bottom plate 41 and arranged on the outer side of the inner cylinder 42, and a disc-like lid plate 44 which abuts and is covered on the other axial end sides of the inner cylinder 42 and the outer cylinder 43. Among the bottom plate 41, the inner cylinder 42, the outer cylinder 43 and the lid plate 44, a cylindrical filling space S1 is formed in which a plurality of ceramic balls 23 are filled over the axial direction (see FIG. 4). Furthermore, on the bottom surface side of the bottom plate 41, the concave portion 46 which enters the convex portion 32 of the partition plate 31 is formed.

Each of the inner cylinder 42 and the outer cylinder 43 is formed so as to regulate the passage of the ceramic balls 23 and allow the passage of the cooling water. Specifically, the inner cylinder 42 and the outer cylinder 43 are formed of woven wire mesh (specifically, plain woven wire mesh) (see FIG. 6). The open mesh of the woven wire mesh is set to a value smaller than the diameter of the ceramic balls 23. Furthermore, the opening rates of the inner cylinder 42 and the outer cylinder 43 are set to substantially the same value.

In the container 22, as shown in FIG. 1, the lid plate 44 is provided in the tank 21 so as to partition the inside of the tank 21 vertically into the container-side space S2 (that is, the space S2 on the side where the container 22 is arranged) and the axial end-side space 54. The lid plate 44 is attached onto the fixing flange 35 of the tank 21 by bolting or the like, with the flange 47 formed on the upper end side of the outer cylinder 43 being interposed therebetween. Further, at the central part of the lid plate 44, a communication part 48 for communicating a space inside the inner cylinder 42 in the container-side space S2 and the axial end-side space S4 is provided. The communication part 48 is constituted by a through hole formed in the lid plate 44. The outlet 28 is provided in a portion forming the axial end-side space S4 of the tank 21 (see FIG. 1). Thus, the outlet 28 allows the cooling water inside the inner cylinder 42 of the container 22 to flow out of the tank 21.

The plurality of ceramic balls 23 are filled in a full state within the filling space Si of the container 22 over the axial direction. Each of the ceramic balls 23 contains tourmaline. Specifically, the ceramic balls 23 are obtained by mixing tourmaline particles with ceramic (clay material), forming them into a doll shape having a particle diameter of about 5 mm, and firing the formed product. Since each ceramic ball 23 is formed to be porous, the permeability of water is high.

### (3) Actions of Cooling Water Circulation System and Water Activator

Next, the actions of the cooling water circulation system 1 and the water activator 20 having the above-described configurations will be described. As shown in FIG. 7, when the cooling water circulating through the cooling tower-side circulation route 2a flows through the branch route 8, the water quality thereof is improved by the actions of the basket filter 9, the underwater impurity separator 10 and the water activator 20, and becomes cooling water excellent in rust prevention and scale prevention and having a cleaning function. On the other hand, the cooling water circulating through the chiller-side circulation route 2b is improved in water quality by the actions of the underwater impurity separator 10 and the water activator 20 when flowing through the bypass route 13, and becomes cooling water excellent in rust prevention and scale prevention and having a cleaning function.

As described above, the cooling water improved in water quality circulates through the respective circulation routes 2a and 2b, thereby suppressing the scale adhesion and deposit, flow path obstruction/corrosion, rust, water leakage/generation of slime and algae. etc. in the mold cooling holes, the cooling pipes, the heat exchanger, etc. due to the deterioration in water quality of the cooling water. As a result, there are obtained various merits such as: the stabilization of the quality of the molded article (the mold can be maintained at a constant temperature, silver defects due to insufficient cooling are unlikely to occur), power and energy saving (significant reduction in power consumption due to improvement in heat exchange rate of the heat exchanger, reduction in CO2 emissions by saving of power and water, and reduction in high pressure abnormal troubles in the heat exchanger), and significant reduction in facility management cost (reduction in electricity charges for facilities, reduction in chemical cleaning cost, and reduction in cleaning maintenance cost).

In the water activator 20, as indicated by broken arrows in FIGS. 1 and 4, the cooling water flowing tangentially from the inlet 27 into the tank 21 becomes a rotational flow around the axial center in the tank 21 (i.e., spiral flow), and flows spirally from the bottom part 21a of the tank 21 toward the top part 21b. Then, the cooling water flows vigorously throughout the entire filling space S1 of the container 22, passes between the respective ceramic balls 23, and flows out of the tank 21 from the inside of the inner cylinder 42 of the container 22 through the outlet 28. As described above, the cooling water flowing vigorously throughout the filling space S1 comes into contact with the ceramic balls 23, so that the cooling water is activated by the radiation effect of far infrared rays of the ceramic balls 23, the piezoelectric effect of tourmaline, etc.

Furthermore, the cooling water flows spirally from the bottom part 21a toward the top part 21b of the tank 21, so that the impurities (for example, impurities of less than 7 μm) contained in the cooling water are collected by the centrifugal force on the outside of the outer cylinder 43, as shown by phantom line arrows in FIG. 1, and dropped. The dropped impurities are recovered in the impurity recovery space S3 via the communication part 33 of the partition plate 31. The impurities recovered in the impurity recovery space S3 are periodically discharged through the drain nozzle 34 by timer control, manual operation, or the like.

### (4) Effects of Example

The water activator 20 of the present Example includes the cylindrical tank 21 in which the water inlet 27 is provided on one axial end side and the water outlet 28 is provided on the other axial end side, the double cylindrical container 22 concentrically arranged within the tank 21, and the plurality of ceramic balls 23 filled in the container 22. The container 22 includes the bottom plate 41, the inner cylinder 42 whose one axial end side is joined onto the bottom plate 41, the outer cylinder 43 whose one axial end side is joined onto the bottom plate 41 and which is arranged outside the inner cylinder 42, and a lid plate 44 covered on the other axial end sides of the inner cylinder 42 and the outer cylinder 43. Among the bottom plate 41, the inner cylinder 42, the outer cylinder 43 and the lid plate 44, the cylindrical filling space S1 in which the plurality of ceramic balls 23 are filled axially is formed. Each of the inner cylinder 42 and the outer cylinder 43 is formed to regulate the passage of the ceramic balls 23 and to allow the passage of the cooling water. Furthermore, the inlet 27 is provided to allow the cooling water to flow tangentially into the tank 21, and the outlet 28 is provided to allow the cooling water inside the inner cylinder 42 of the container 22 to flow out of the tank 21.

Thus, the cooling water which flows tangentially from the inlet 27 into the tank 21 becomes a rotational flow around the axial center in the tank, and flows spirally from the bottom part 21a of the tank 21 to the top part 21b. Then, the cooling water flows vigorously throughout the entire filling space S1 of the container 22, passes between the respective ceramic balls 23, and flows out of the tank 21 from the inside of the inner cylinder 42 of the container 22 through the outlet 28. Thus, the cooling water flowing vigorously throughout the cylindrical filling space S1 comes into contact with the ceramic balls 23, so that the cooling water is effectively activated by the radiation effect of far infrared rays of the ceramic balls 23, the piezoelectric effect of tourmaline, etc. while suppressing the pressure loss. Further, since the plurality of ceramic balls 23 are filled in a full state in the cylindrical filling space S1, the ceramic balls 23 are hard to be stirred by the force of the cooling water and worn, and it is possible to prolong the replacement cycle for the ceramic bails 23 or to eliminate the replacement thereof. Furthermore, as compared with conventional ones in which the ceramic balls are held in a thin layer form in the frame, the water activator 20 can be downsized as a whole.

Also, in the present Example, the tank 21 is installed so that one axial end side forms the bottom part 21a and the other axial end side forms the top part 21b. Thus, the cooling water spirally flows from the bottom part 21a toward the top part 21b of the tank 21, whereby the impurities contained in the cooling water are collected on the outside of the outer cylinder 43 by the centrifugal force and dropped. Therefore, the impurities can be easily recovered at the bottom part 21a of the tank 21.

Further, in the present Example, the bottom part 21a of the tank 21 is provided with the partition plate 31 which partitions the inside of the tank 21 vertically into the container-side space S2 and the impurity recovery space S3. The partition plate 31 is provided with the communication part 33 for communicating the space outside the outer cylinder 43 with the impurity recovery space S3. Thus, the impurities collected on the outside of the outer cylinder 43 by the centrifugal force and dropped are recovered in the impurity recovery space S3 via the communication part 33 of the partition plate 31. In particular, in the present Example, the bottom plate 41 of the container 22 is placed on the partition plate 31. Thus, the detachability of the container 22 to the tank 21 is improved.

Further, in the present Example, the inner cylinder 42 and the outer cylinder 43 are formed by woven wire mesh. Thus, the wear of the ceramic balls 23 due to the contact with the inner cylinder 42 and the outer cylinder 43 is suppressed.

Further, in the present Example, the tank 21 includes the main body 25 and the lid member 26, and the lid member 26 is provided with the see-through part through which the inside of the main body 25 can be seen. Hence, the state of the activated cooling water can be confirmed by the see-through part.

Further, in the present Example, the inlet 27 includes the inflow nozzle 27a, and the inflow nozzle 27a is arranged so that its axial center C2 is parallel to the reference line L orthogonal to the axial center C1 of the tank 21 as viewed from the axial direction of the tank 21. As a result, the water flows tangentially into the tank 21 by the inflow nozzle 27a, so that a rotational flow of the cooling water around the axial center is effectively generated in the tank 21.

Further, in the present Example, the container 22 is provided in the tank 21 so that the lid plate 44 partitions the inside of the tank 21 into the container-side space S2 and the axial end-side space S4 in the axial direction. The lid plate 44 is provided with the communication part 48 for communicating the space inside the inner cylinder 42 with the axial end-side space S4, and the outlet 28 is provided in a portion forming the axial end-side space 54 of the tank 21. Thus, the cooling water which has passed between the respective ceramic halls 23 reaches the axial end-side space S4 from the inside of the inner cylinder 42 through the communication part 48, and flows out of the tank 21 through the outlet 28.

The cooling water circulation system 1 of the present Example, the above-described water activator 20 is provided in the circulation route 2. As a result, it is possible to effectively activate the cooling water circulated in a large quantity and at high water pressure. By circulating the cooling water with improved water quality in the circulation route 2, it is possible to prevent the contamination and clogging of the circulation route 2, and to maintain the water quality of the cooling water.

The present invention is not limited to the above-described Example, and can be variously modified within the scope of the present invention depending on the purpose and use. Specifically, the tank 21 installed so that its axial center is along the perpendicular direction has been illustrated in the above-described Example, but the present invention is not limited to this, For example, the tank may be installed so that its axial center is inclined in the perpendicular direction or may be installed so that its axial center is along the horizontal direction.

Moreover, in the above-described Example, the inlet 27 is provided in the bottom part 21a of the tank 21, and the outlet 28 is provided in the top part 21b of the tank 21. However, the present invention is not limited to this. For example, the inlet 27 may be provided in the top part 21b of the tank 21, and the outlet 28 may be provided in the bottom part 21a of the tank 21. Moreover, in the above-described Example, the nozzle-like inlet 27 and/or outlet 28 have/has been illustrated, but the present invention is not limited to this. For example, the inlet and/or outlet may be in a hole-like form.

Moreover, in the above-described Example, the lid member 26 which serves as the see-through part as a whole has been illustrated, but the present invention is not limited to this. For example, a lid member in which a see-through part is formed in part may be employed.

Moreover, the inner cylinder 42 and/or the outer cylinder 43 formed of woven wire mesh have/has been illustrated in the above-described Example, but the present invention is not limited to this. For example, the inner cylinder and/or outer cylinder may be formed of a perforated plate such as a punching metal. In this case, it is preferable to provide a chamfered part or an R-shaped part on the circumference of each hole of the perforated plate.

Moreover, in the above-described Example, the communication part 33 is formed by a through hole formed in the partition plate 31, but the present invention is not limited to this. For example, the communication part may be formed by a notch formed on the outer edge side of the partition plate 31.

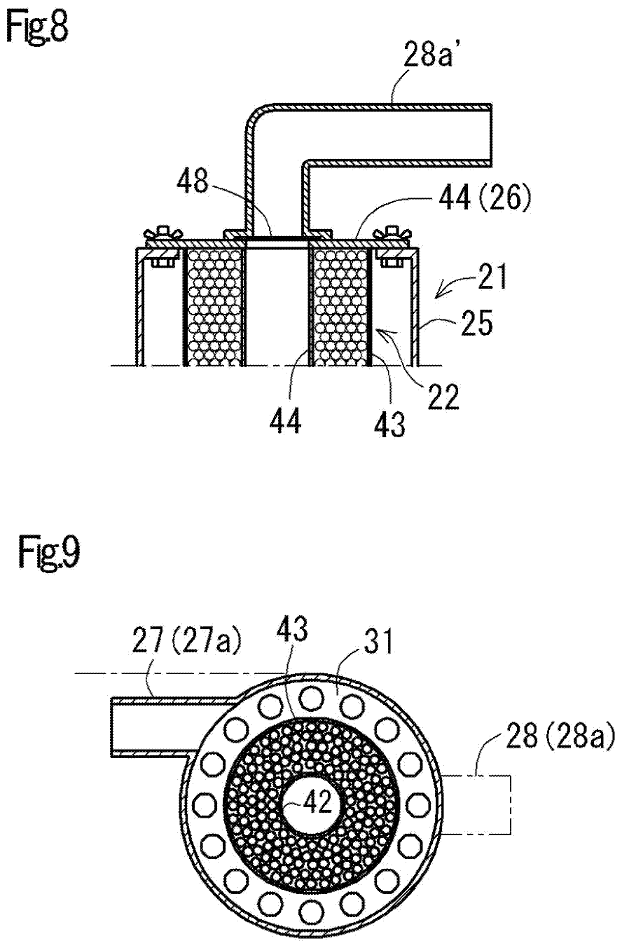

In the above embodiment, the inside of the tank 21 is partitioned axially by the lid plate 44, and the outlet 28 is provided in the portion forming the axial end-side space S4 of the tank 2 However, the invention is not limited to this. For example, as shown in FIG. 8, the lid plate 44 may cover the respective openings of the container 22 and the tank main body 25, and an outflow pipe 28a′ may be connected to the communication part 48 formed in the lid plate 44. In this case, the lid plate 44 functions also as the lid member 26 of the tank 21.

Moreover, in the above-described Example, the inflow nozzle 27a arranged on the tangent line of the tank 21 has been illustrated, but the present invention is not limited to this. For example, an inflow nozzle 27a′ arranged on a line moved in parallel to the center side from the tangent line of the tank 21, as shown in FIG. 9, may be employed.

Furthermore, in the above-described Example, the water activator 20 for activating the cooling water circulating in the circulation route 2 of the cooling water circulation system I has been illustrated. However, the present invention is not limited to this. For example, a water activator for activating tap water may be employed. In this case, the water activator may be installed separately from the faucet, or may be integrally attached to the faucet.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

### INDUSTRIAL APPLICABILITY

The present invention is widely used as a technique for activating water.

### REFERENCE SIGNS LIST

1 Cooling water circulation system

2 Circulation route

20 Water activator

21 Tank

21a Bottom part

21b Top part

22 Container

23 Ceramic ball

25 Main body

26 Lid member

27 Inlet

27a Inflow nozzle

28 Outlet

31 Partition plate

33 Communication part

41 Bottom plate

42 Inner cylinder

43 Outer cylinder

44 Lid plate

48 Communication part

S1 Filling space

S2 Container-side space

S3 Impurity recovery space

S4 Axial end-side space

1. A water activator for activating water, comprising:
a cylindrical tank provided with a water inlet on one axial end side and a water outlet on another axial end side;
a double cylindrical container concentrically arranged within the tank; and
a plurality of granular water activating materials filled in the container,
wherein the container includes a bottom plate, an inner cylinder whose one axial end side is joined onto the bottom plate, an outer cylinder whose one axial end side is joined onto the bottom plate and which is arranged outside the inner cylinder, and a lid plate covered on the other axial end sides of the inner cylinder and the outer cylinder,
wherein a cylindrical filling space in which the plurality of granular water activating materials are filled over an axial direction is formed among the bottom plate, the inner cylinder, the outer cylinder, and the lid plate,
wherein each of the inner cylinder and the outer cylinder is formed to regulate passage of the granular water activating materials and to allow passage of water,
wherein the inlet is provided to allow water to flow tangentially into the tank, and
wherein the outlet is provided to allow the water inside the inner cylinder of the container to flow out of the tank.

2. The water activator according to claim 1, wherein the tank is installed so that one axial end side forms a bottom part and that another axial end side forms a top part.

3. The water activator according to claim 2,
wherein a partition plate which partitions an inside of the tank vertically into a container-side space and an impurity recovery space is provided in the bottom part of the tank, and
wherein the partition plate is provided with a communication part for communicating a space outside the outer cylinder in the container-side space with the impurity recovery space.

4. The water activator according to claim 1, wherein at least the inner cylinder of the inner cylinder and the outer cylinder is formed of woven wire mesh.

5. The water activator according to claim 1,
wherein the tank includes a bottomed cylindrical main body opened on one axial end side, and a lid member detachably attached to an axial end side of the main body so as to close the opening of the main body, and
wherein the lid member is provided with a see-through part through which an inside of the main body can be seen.

6. The water activator according to claim 1,
wherein the inlet includes an inflow nozzle connected to an outer peripheral surface of the tank, and
wherein the inflow nozzle is arranged so that its axial center is parallel to a reference line orthogonal to an axial center of the tank as viewed from an axial direction of the tank.

7. The water activator according to claim 1,
wherein the container is provided in the tank so that the lid plate partitions the inside of the tank axially into the container-side space and an axial end-side space,
wherein the lid plate is provided with a communication part for communicating a space inside the inner cylinder in the container-side space with the axial end-side space, and
wherein the outlet is provided in a portion forming the axial end-side space of the tank.

8. The water activator according to claim 1, wherein the granular water activating materials are ceramic balls.

9. The water activator according to claim 1, wherein the water is cooling water circulated in a circulation route.

10. A cooling water circulation system for circulating cooling water in a circulation route, wherein the water activator according to claim 1 is provided in the circulation route.
